(19) United States
(12) Patent Application Publication
(10) Pub. No.: US 2007/0264123 A1
(43) Pub. Date: Nov. 15, 2007

(54) COUNTER-ROTATING FAN

(75) Inventor: Yusuke Yoshida, Kyoto (JP)

Correspondence Address: NIDEC CORPORATION;c/o KEATING & BENNETT, LLP, 8180 GREENSBORO DRIVE, SUITE 850, MCLEAN, VA, 22102, US

(73) Assignee: NIDEC CORPORATION, Kyoto (JP)

(21) Appl. No.: 11/746,716

(22) Filed: May 10, 2007

(30) Foreign Application Priority Data
May 10, 2006 (JP) 2006-131426

(51) Int. Cl. F03D 1/02

(52) U.S. Cl. 416/128

(57) ABSTRACT

A counter-rotating fan includes first and second fans that are coaxially arranged. The first ribs of the first fan and the second ribs of the second fan are arranged on an air-outlet side and an air-inlet side of the first impeller of the first fan, respectively. The first impeller includes first blades. When seen in an axial direction from the second fan side, while the first rib side edge of each first blade is at least partly located above one first rib, the second rib side edge of that first blade is not located below any second rib but is entirely located between two second ribs. Thus, interference of air taken in by the first blades with the second ribs and interference of air sent out by the first blades with the first ribs cannot occur simultaneously, resulting in improvement of the sound characteristics of the counter-rotating fan.

### BACKGROUND OF THE INVENTION

1. Field of the Invention

The present invention relates to a counter-rotating fan including coaxially arranged fans.

2. Description of the Related Art

Electronic devices such as personal computers and servers include cooling fans for cooling electronic components inside the respective electronic devices. With increases in the density of arrangement of the electronic components, the cooling fans are required to have higher cooling performance. In particular, relatively large-sized electronic devices, e.g., servers, require cooling fans which are high in both a static pressure and an airflow rate.

Moreover, for the cooling fans for use in electronic devices, improvements in sound characteristics have been also required, for example, from a viewpoint of improvement of a working environment where the electronic devices are used. One standard used for estimating the sound characteristics is a prominence ratio indicating a ratio of a prominent discrete tone in audible areas. As the prominence ratio decreases, the sound characteristics are improved.

In a case where fans are arranged in series as in a counter-rotating axial fan, for example, ribs for supporting an impeller in each fan are arranged on the same side of the impeller for design purposes or the like. This means that the ribs are arranged on both sides of one impeller, i.e., on both an air-inlet side and an air-outlet side. Thus, a change in a current of air or a pressure of air on the air-inlet side and the air-outlet side of the impeller during rotation of the impeller may interfere with the ribs so as to lower the sound characteristics, that is, make harsh noises in the audible bands louder.

### SUMMARY OF THE INVENTION

According to preferred embodiments of the present invention, a counter-rotating fan includes a first impeller having a plurality of first blades radially arranged about a center axis; a first motor rotating the first impeller about the center axis in a first rotating direction; a second impeller having a plurality of second blades which are radially arranged about the center axis, the second impeller arranged adjacent to the first impeller along the center axis; a second motor rotating the second impeller in a second rotating direction opposite to the first rotating direction; a hollow housing surrounding the first and second impellers; and a plurality of first ribs and a plurality of second ribs radially arranged about the center axis to connect the first motor and the second motor to the housing, respectively. The first ribs are arranged on a side of the first impeller opposite to the second impeller. The second ribs are arranged between the first impeller and the second impeller. When seen from the second fan side, while at least an outer portion of a first rib side edge of each of the first blades in a radial direction that is substantially perpendicular to the center axis is located above one of the first ribs, at least an outer portion of a second rib side edge of the first blade in the radial direction is located between two of the second ribs. The outer portion of each of the first rib side edge and the second rib side edge in the radial direction is a portion that is outside a center of the corresponding edge in the radial direction.

Other features, elements, advantages and characteristics of the present invention will become more apparent from the following detailed description of preferred embodiments thereof with reference to the attached drawings.

### BRIEF DESCRIPTION OF THE DRAWINGS

FIG. 1 is a perspective view of a counter-rotating fan according to a first preferred embodiment of the present invention.

FIG. 2 is an exploded perspective view of the counter-rotating fan of FIG. 1.

FIG. 3 is a cross-sectional view of the counter-rotating fan of FIG. 1, taken along a plane containing a center axis of the fan.

FIG. 4 is a plan view of a fist axial fan in the counter-rotating fan of FIG. 1.

FIG. 5 is a plan view of a second axial fan in the counter-rotating fan of FIG. 1.

FIG. 6 is another plan view of the first axial fan in the counter-rotating fan of FIG. 1.

FIG. 7 shows cross-sections of a first blade, a first rib, and a second rib in the first preferred embodiment of the present invention.

FIG. 8 is a plan view of a first axial fan in a counter-rotating fan according to a second preferred embodiment of the present invention.

FIG. 9 shows cross-sections of a first blade, a first rib, and a second rib in the second preferred embodiment of the present invention.

### DETAILED DESCRIPTION OF PREFERRED EMBODIMENTS

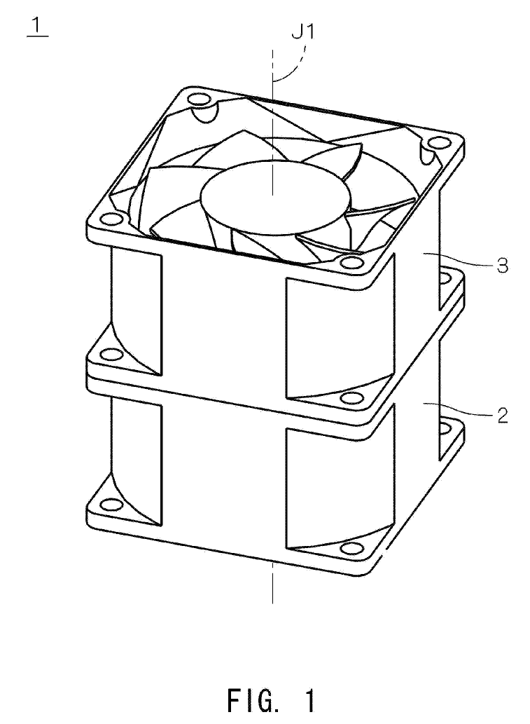

Referring to FIGS. 1 through 9, preferred embodiments of the present invention will be described in detail. It should be noted that in the explanation of the present invention, when positional relationships among and orientations of the different components are described as being up/down or left/right, ultimately positional relationships and orientations that are in the drawings are indicated; positional relationships among and orientations of the components once having been assembled into an actual device are not indicated. Meanwhile, in the following description, an axial direction indicates a direction parallel to a rotation axis, and a radial direction indicates a direction perpendicular to the rotation axis.

### First Preferred Embodiment

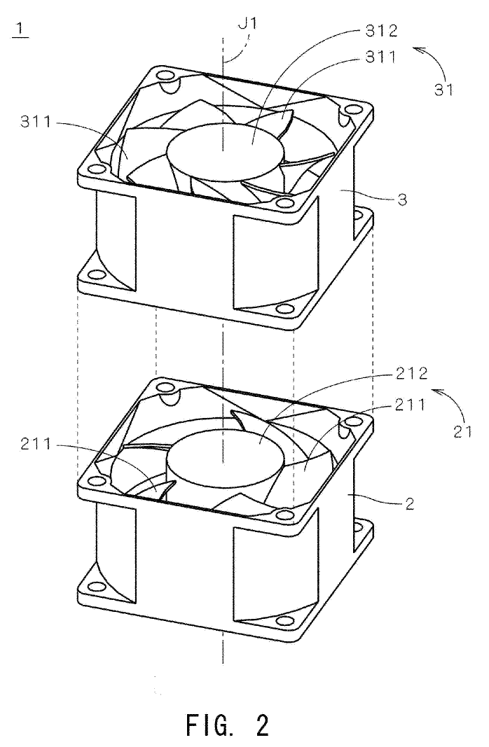

FIG. 1 is a perspective view of a counter-rotating fan 1 according to a first preferred embodiment of the present invention. FIG. 2 is an exploded view of the counter-rotating fan 1 of FIG. 1. The counter-rotating fan 1 is preferably used, for example, as an electric cooling fan which cools an electronic device such as a server, for example. As shown in FIG. 1, the counter-rotating fan 1 includes a first axial fan 2 and a second axial fan 3 which are coaxially arranged in series along a center axis J1 of the counter-rotating fan 1. In this preferred embodiment, the second axial fan 3 is arranged axially above the first axial fan 2, as shown in FIG. 1. The first and second axial fans 2 and 3 are secured to each other, for example, by screwing, or another fastening means or method.

When the first and second axial fans 2 and 3 are driven in the counter-rotating fan 1, air is taken in from above the second axial fan 3 and is sent downward in an axial direction that is substantially parallel or parallel to the center axis J1, i.e., toward the first axial fan 2, thereby creating a current of air flowing downward in the axial direction. In the following description, the upper side in FIG. 1 from which air is taken in is referred to as an “air-inlet side” and the lower side in FIG. 1 from which air is discharged is referred to as an “air-outlet side”. Moreover, the air-inlet side and the air-outlet side are also referred to as the second fan side and the first side of the counter-rotating fan.

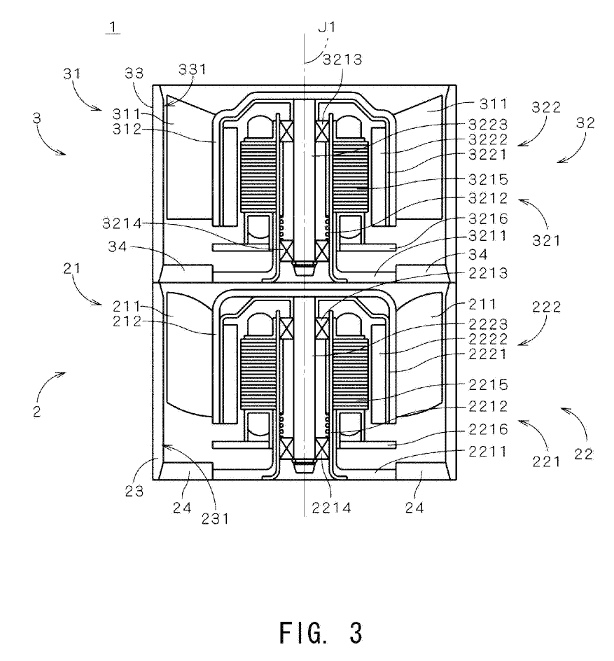

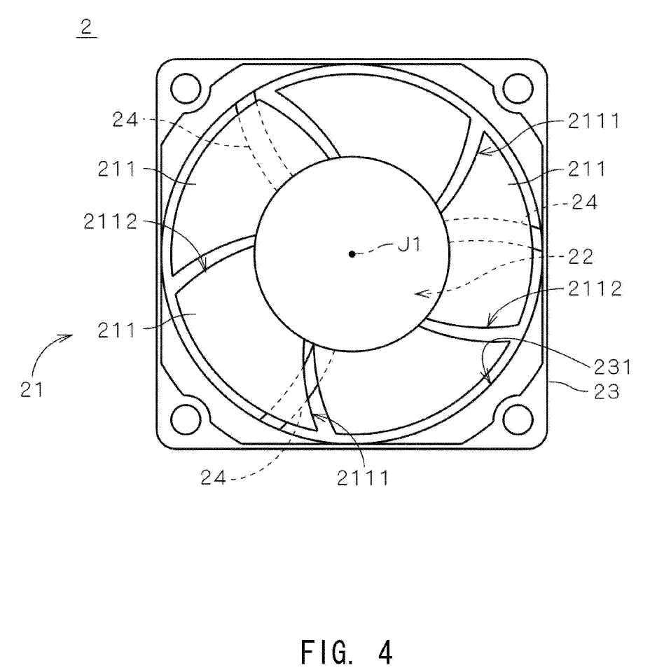

FIG. 3 is a cross-sectional view of the counter-rotating fan 1, taken along a plane containing the center axis J1. FIG. 4 is a plan view of the first axial fan 2 when seen from the air-inlet side.

As shown in FIGS. 3 and 4, the first axial fan 2 includes a first impeller 21 having a plurality of first blades 211, a first motor 22, a first housing member 23, and a plurality of first ribs 24. In this preferred embodiment, five first blades 211 and three first ribs 24 are preferably provided, for example. The first blades 211 are radially arranged about the center axis J1 at regular intervals. The first motor 22 rotates the first impeller 21 about the center axis J1 in a first rotating direction so as to create a current of air flowing in the axial direction. In the shown example, the first rotating direction is a counterclockwise direction in FIGS. 2 and 4. The current of air created by rotation of the first impeller 21 flows downward in the axial direction in FIG. 3. The first housing member 23 defines a hollow cylinder which accommodates the first impeller 21 and the first motor 22 therein. The first housing member 23 is arranged outside the first impeller 21 in a radial direction that is substantially perpendicular or perpendicular to the axial direction, thereby surrounding the first impeller 21. The first ribs 24 are radially arranged about the center axis J1 to connect the first motor 22 to the first housing member 23. In this manner, the first ribs 24 support the first motor 22.

Referring to FIG. 3, the first motor 22 includes a stator 221 as a stationary assembly and a rotor 222 as a rotating assembly. The rotor 222 is supported by a bearing assembly described later, in a rotatable manner about the center axis J1 relative to the stator 221. In the following description, the rotor side and the stator side in the axial direction are referred to as upper and lower sides in the axial direction for the sake of convenience, respectively. However, it is unnecessary that the axial direction is coincident with a direction of gravity.

The stator 221 includes a base portion 2211. The base portion 2211 has an approximately annular shape centered on the center axis J1 when seen in the axial direction. The base portion 2211 is secured to an inner side surface 231 of the first housing member 23 with the first ribs 24, as shown in FIGS. 3 and 4, and supports other components of the stator 221. The base portion 2211 is preferably made of resin and is preferably formed by injection molding together with the first ribs 24 and the first housing member 23 both of which are also preferably made of resin.

The base portion 2211 has an opening at its center. Referring to FIG. 3, a hollow, approximately cylindrical bearing holder 2212 is secured to a portion of the base portion 2211 defining the opening. The bearing holder 2212 extends upward (i.e., toward the rotor 222) from the base portion 2211. Inside the bearing holder 2212, ball bearings 2213 and 2214 are arranged in an upper portion and a lower portion in the axial direction, respectively. The ball bearings 2213 and 2214 define a portion of the bearing assembly.

The stator 221 also includes an armature 2215 arranged radially outside the bearing holder 2212. In the stator 221, a circuit board 2216 preferably in the form of an approximately annular plate is attached axially below the armature 2215 and is electrically connected to the armature 2215. A circuit (not shown) on the circuit board 2216 controls the armature 2215. The circuit board 2216 is connected to an external power supply provided outside the counter-rotating fan 1 via a bundle of lead wires. The bundle of lead wires and the external power supply are not shown in FIG. 3.

The rotor 222 includes a yoke 2221 made of magnetic metal. The yoke 2211 is hollow and approximately cylindrical, is centered on the center axis J1, and is provided with a lid for closing an axially upper end of the yoke 2211. In the rotor 222, a hollow, approximately cylindrical magnet 2222 for generating a magnetic field is secured to an inner surface of a sidewall of the yoke 2221, i.e., an inner side surface of the yoke 2221. The magnet 2222 is arranged to face the armature 2214.

The rotor 222 further includes a shaft 2223 extending from the lid of the yoke 2221 downward in the axial direction. The shaft 2223 is inserted into the bearing holder 2212 and is supported by ball bearings 2213 and 2214 in a rotatable manner. In the first axial fan 2, the shaft 2223 and the ball bearings 2213 and 2214 form the bearing assembly which supports the yoke 2221 in a rotatable manner about the center axis J1 relative to the base portion 2211.

The first impeller 21 includes a hollow, approximately cylindrical hub 212 which has a lid closing an axially upper end thereof. The hub 212 covers the outside of the yoke 2221 of the first motor 22. The first impeller 21 also includes a plurality of first blades 211 radially extending from the outside of a sidewall of the hub 212, i.e., an outer side surface of the hub 212. The hub 212 and the first blades 211 are preferably made of resin and are preferably formed by injection molding together.

In the first axial fan 2, a driving current is supplied to the armature 2215 via the circuit board 2216 of the first motor 22. This driving current is controlled, thereby generating a torque centered on the center axis J1 by interaction between the armature 2215 and the magnet 2222. The torque rotates the rotor 222 about the center axis J1 so as to turn the first blades 211 of the impeller 21 attached to the rotor 222 around the center axis J1 in a counterclockwise direction in FIG. 4. Thus, air is taken in from the upper side in FIG. 3, i.e., the second axial fan side and is sent to the lower side in FIG. 3, i.e., toward the first ribs 24.

Referring to FIG. 2, in the first impeller 21 of the first axial fan 2, a radially inner edge of each first blade 211 is located on an outer side surface of the hub 212 and is arranged at an angle relative to the center axis J1. The radially inner edge of each first blade 211 extends toward an upstream side in the rotating direction of the first impeller 21, as it moves from the air-inlet side to the air-outlet side along the center axis J1 (i.e., downward in the axial direction in FIG. 2). That is, the air-inlet side edge of each first blade 211 is located ahead of the air-outlet side edge thereof in the rotating direction of the first impeller 21 which is a counterclockwise direction in FIG. 4. Hereinafter, the air-inlet side edge 2111 and the air-outlet side edge 2112 of each first blade 211 are referred to as a leading edge and a trailing edge.

In the first axial fan 2, the first ribs 24 arranged on the air-outlet side of the first impeller 21 are radially arranged about the center axis J1 at regular intervals, as shown in FIG. 4. More specifically, both points of connection between the first ribs 24 and the first motor 22 and points of connection between the first ribs 24 and the first housing member 23 are regularly arranged about the center axis J1, respectively. Each first rib 24 is arranged at an angle relative to a line which extends from a radially inner end of that first rib 24 in the radial direction, so as to move farther away from that line in an opposite direction to the first rotating direction of the first impeller 21 as it moves away from the center axis J1.

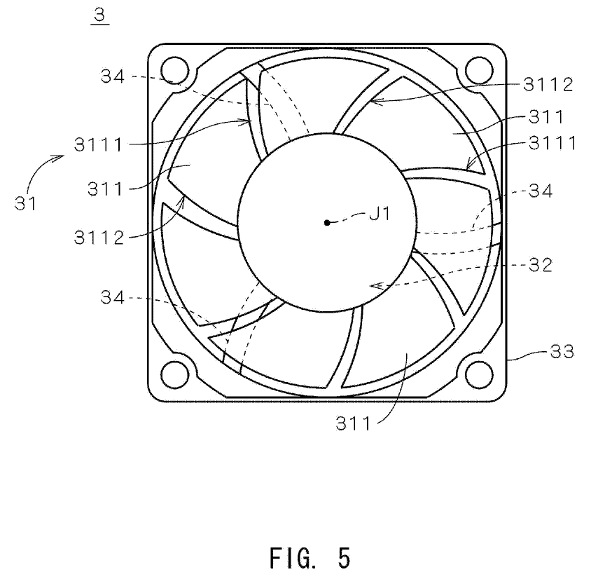

FIG. 5 is a plan view of the second axial fan 3 when seen from the air-inlet side (i.e., from the second fan side). Referring to FIGS. 3 and 5, the second axial fan 3 includes a second impeller 31 arranged adjacent to the first impeller 21 in the axial direction. The second impeller 31 has a plurality of second blades 311 radially arranged about the center axis J1 at regular intervals. In this preferred embodiment, seven second blades 311 are preferably provided, for example.

The second axial fan 3 also includes a second motor 32, a second housing member 33, and a plurality of second ribs 34. In this preferred embodiment, three second ribs 34 are preferably provided, for example. The second motor 32 rotates the second impeller 31 about the center axis J1 in a second rotating direction opposite to the first rotation direction of the first impeller 21 so as to create a current of air flowing in the same direction as that created by the first impeller 21. In the shown example, the second rotating direction is a clockwise direction in FIGS. 2 and 5. The current of air created by rotation of the second impeller 31 flows downward in the axial direction in FIG. 3. The second housing member 33 is arranged outside the second impeller 31 in the radial direction to surround the second impeller 31. The second housing member 33 has an inner side surface 331 defining a hollow cylinder in which the second impeller 31 and the second motor 32 are accommodated. The second ribs 34 are arranged between the first and second impellers 21 and 31, and radially extend from the second motor 32 to the second housing member 33. That is, the second ribs 34 connect the second motor 33 to the second housing member 33. In this preferred embodiment, the number of the second ribs 34 is equal to the number of the first ribs 24 (see FIG. 4).

The second motor 32 preferably has substantially the same structure as the first motor 22. Referring to FIG. 3, the second motor 32 includes a stator 321 and a rotor 322 arranged axially above the stator 321 (i.e., on the air-intake side of the stator 321). The second motor 32 is supported in a rotatable manner relative to the stator 321.

The stator 321 includes a base portion 3211 secured to the inner side surface 331 of the second housing member 33 with the second supporting ribs 34. The base portion 3211 supports other components of the stator 321. The stator 321 also includes a hollow, approximately cylindrical bearing holder 3212 with ball bearings 3213 and 3214 arranged therein, an armature 3215 arranged outside the bearing holder 3212, and a circuit board 3216 preferably in the form of an approximately annular plate which is attached axially below the armature 3215. The circuit board 3216 is electrically connected to the armature 3215. A circuit (not shown) on the circuit board 3216 controls the armature 3215.

The base portion 3211 is preferably made of resin and is preferably formed by injection molding together with the second supporting ribs 34 and the second housing member 33 both of which are made of resin. The circuit board 3216 is connected to an external power supply provided outside the counter-rotating fan 1 via a bundle of lead wires.

The rotor 322 includes a metal yoke 3221, a magnet 3222 for generating a magnetic field, secured to an inner side surface of the yoke 3221, and a shaft 3223 extending downward from the yoke 3221. The shaft 3223 is supported by the ball bearings 3213 and 3214 in the bearing holder 3212 in a rotatable manner. In the second axial fan 3, the shaft 3223 and the ball bearings 3213 and 3214 define together a bearing assembly for supporting the yoke 3221 in a rotatable manner about the center axis J1 relative to the base portion 3211.

The second impeller 31 includes a hollow, approximately cylindrical hub 312 with a lid, and a plurality of second blades 311 radially extending from an outer side surface of the hub 312. The hub 312 covers the outside of the yoke 3221 of the second motor 32. The hub 312 and the second blades 312 are preferably made of resin and are preferably formed by injection molding together.

When the second motor 32 is driven in the second axial fan 3, the second blades 311 of the second impeller 31 are turned about the center axis J1 in a clockwise direction in FIG. 5. Thus, air is taken into the second axial fan 3 from above the second axial fan 3 (from above the rotor 322 of the second motor 32) and is discharged downward in the axial direction, i.e., toward the second ribs 34 and the first axial fan 2.

As shown in FIG. 2, a radially inner edge of each second blade 311 of the second impeller 31 is located on the outer side surface of the hub 312 and is arranged at an angle relative to the center axis J1 in a similar manner to that of the radially inner edge of each first blade 211 of the first impeller 21. The radially inner edge of each second blade 311 extends toward an upstream side in the rotating direction of the second impeller 31, as it moves from the air-inlet side to the air-outlet side along the center axis J1. That is, the air-inlet side edge 3111 of each second blade 31 is located ahead of the air-outlet side edge 3112 thereof in the rotating direction of the second impeller 31 (i.e., a clockwise direction in FIG. 5). Hereinafter, the air-inlet side edge 3111 and the air-outlet side edge 3112 of each second blade 311 are referred to as a leading edge and a trailing edge, respectively.

Referring to FIG. 5, in the second axial fan 3, the second ribs 34 on the air-outlet side of the second impeller 31 are radially arranged about the center axis J1 at regular intervals, as in the first axial fan 2. Each second rib 34 is at arranged an angle relative to a line which radially extends from a radially inner end of that second rib 34, so as to move farther away from that line in an opposite direction to the second rotating direction of the second impeller 31 as it moves away from the center axis J1.

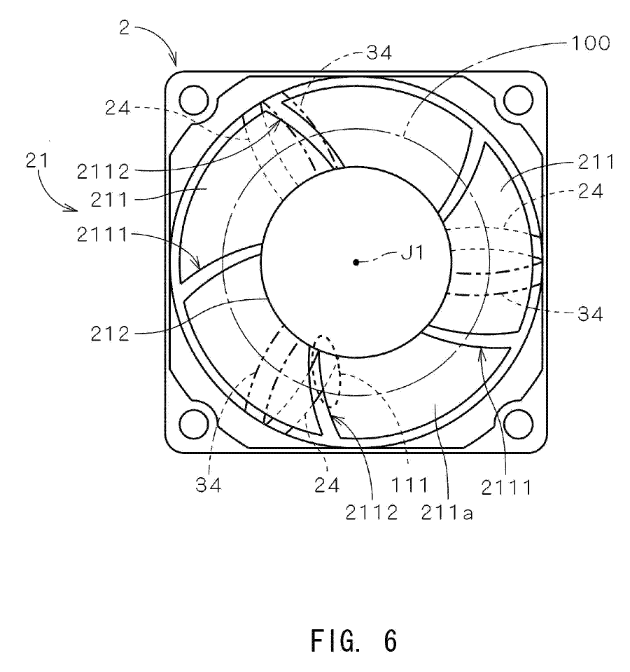

FIG. 6 is a plan view of the first axial fan 2 when seen from the air-inlet side (i.e., the second axial fan side). FIG. 6 also shows with chain double-dashed line the second ribs 34 of the second axial fan 3 which sandwich the first impeller 21 together with the first ribs 24 in the axial direction. In the counter-rotating fan 1, the entire portion of every first rib 24 is located between two second ribs 34 without being covered by any of the second ribs 34, when seen in the axial direction from the second fan side, as shown in FIG. 6.

In the state shown in FIG. 6, a trailing edge 2112 of one of five first blades 211 which is shown as the lowermost first blade 211a is partly located above one first rib 24, when seen in the axial direction from the second fan side. The trailing edge 2112 of the first blade 211a is a first rib side edge. As shown in FIG. 6, when seen from the second fan side, while a portion of the trailing edge 2112 of the first blade 211a is located axially above one first rib 24, the entire portion of the leading edge 2111 (i.e., the second rib side edge) of the first blade 211a is not located below any of the second ribs 34. Instead, the entire portion of the leading edge 2111 is located between two second ribs 34.

In the counter-rotating fan 1, the first blades 211, the first ribs 24, and the second ribs 34 are regularly arranged about the center axis J1 at respective intervals. Thus, while a portion of the trailing edge 2112 of each first blade 211 is located axially above a given first rib 24, the leading edge 2111 of that first blade 211 is located between two second ribs 34 without being covered by any of the second ribs 34, when seen from the second fan side in the axial direction.

Thus, simultaneous occurrence of interference of air introduced into the first axial fan 2 by the first blades 211 with the second ribs 34 and interference of air sent out by the first blades 211 with the first ribs 24 are reliably prevented. As a result, the sound characteristics of the counter-rotating fan 1 are greatly improved. In particular, a prominence ratio indicating a ratio of prominent discrete tone in audible areas, which is one of standards for evaluating the sound characteristics, is significantly reduced.

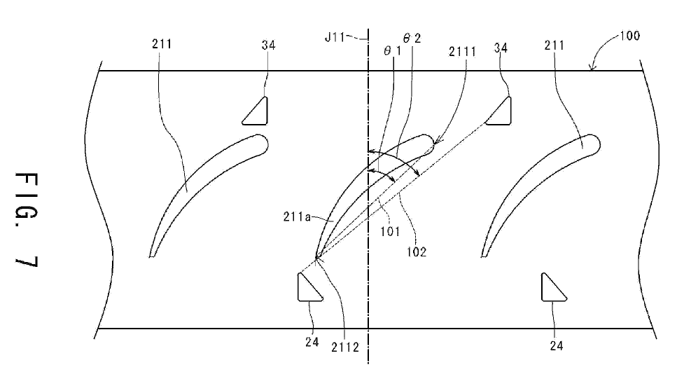

FIG. 7 is a cross-sectional view of the first blades 211, the first ribs 24, and the second ribs 34 of the counter-rotating fan 1, taken along a cylindrical surface 100 which defines a cylinder having a predetermined diameter and centered on the center axis J1 (shown with dashed-dotted line in FIG. 6). FIG. 7 shows cross sections of those members 211, 24, and 34 when a portion of the cylindrical surface 100 is developed in its circumferential direction. FIG. 7 also shows the axial direction J11.

In FIG. 7, a line 101 connects both ends of the first blade 211a, i.e., the leading edge 2111 and the trailing edge 2112 to each other on the cylindrical surface 100. On the developed surface 100, the line 101 is arranged at an angle θ1 relative to the axial direction J11. FIG. 7 also shows a line 102 on the surface 100, which connects the closest first rib 24 to the trailing edge 2112 of the first blade 211a to the closest second rib 34 to the leading edge 2111 of the first blade 211a on the developed cylindrical surface 100. The line 102 is arranged at an angle θ2 relative to the axial direction J11. In FIG. 7, both the lines 101 and 102 are shown with broken line.

As shown in FIG. 7, the angles θ1 and θ2 of the lines 101 and 102 with respect to the axial direction J11 on the developed cylindrical surface 100 are different from each other. Moreover, the angle θ1 of the line 101 is different from an angle of a line connecting a given first rib 24 to a given second rib 34 with respect to the axial direction J11 on the developed cylindrical surface 100. Even when the diameter of the cylinder defined by the cylindrical surface 100 is changed between an outer diameter of the hub 212 of the first impeller 21 (see FIG. 6) and an outer diameter of the first impeller 21, the angle θ1 of the line 101 connecting the leading and trailing edges 2111 and 2112 of the first blade 211a with respect to the center axis J1 is different from an angle of a line connecting a given first rib 24 to a given second rib 34 with respect to the center axis J1 on the developed cylindrical surface 100.

In the counter-rotating fan 1, all the first blades 211 are preferably arranged at the same angle relative to the center axis J1, and the first blades 211, the first ribs 24, and the second ribs 34 are regularly arranged at their own intervals, respectively. Thus, when the first blades 211, the first ribs 24, and the second ribs 34 are cut by a cylindrical surface which defines a cylinder having a given diameter and centered on the center axis J1, an angle of a line connecting leading and trailing edges of each first blade 211 with respect to the center axis J1 on the developed cylindrical surface is different from a line connecting a given first rib 24 to a given second rib 34 with respect to the axial direction J11 on the developed surface. In other words, for each first blade 211, both the first rib 24 and the second rib 34 cannot be simultaneously located on an extended line of the line connecting the leading and trailing edges of that first blade 211 to each other.

With this configuration, it is possible to prevent simultaneous occurrence of interference of air introduced into the first axial fan 2 by the first blades 211 with the second ribs 34 and interference of air sent out by the first blades 211 with the first ribs 24. Thus, the sound characteristics of the counter-rotating fan 1 are greatly improved. In particular, a prominence ratio is significantly reduced.

As described above, in the counter-rotating fan 1 of this preferred embodiment, the first impeller 21 sandwiched between the second ribs 34 on the air-inlet side and the first ribs 24 on the air-outlet side is designed to satisfy the following conditions. First, the leading edge 2111 of each first blade 211 is not located below a closest second rib 34 to that leading edge 2111 while the trailing edge 2112 of that first blade 211 is at least partly located above a closest first rib 24 to that trailing edge 2112, and vice versa. Second, the angle of each first blade 211 with respect to the center axis J1, i.e., the angle of the line connecting the leading and trailing edges of the first blade 211 with respect to the center axis J1 is different from the angle of the line connecting the closest first rib 24 to that first blade 211 to the closest second rib 24 to that first blade 211 with respect to the center axis J1. When the above two conditions are satisfied, the sound characteristics of the counter-rotating fan 1 can be improved. Moreover, it is preferable that no second rib 34 be located axially above each first rib 24. In this case, the sound characteristics of the counter-rotating fan 1 are improved even more.

In the counter-rotating fan 1 of this preferred embodiment, the number of the first ribs 24 is preferably equal to the number of the second ribs 34. Thus, the above two conditions for arranging the first blades 211, the first ribs 24, and the second ribs 34 can be easily satisfied. In other words, the arrangement of the first and second ribs suitable for improving the sound characteristics of the counter-rotating fan 1 can be easily achieved.

In the counter-rotating fan 1 of this preferred embodiment, each of the first ribs 24 arranged on the air-outlet side of the first impeller 21 is at an angle to a line extending from the radially inner end of that first rib 24 in the radial direction such that that first rib 24 moves farther away from that line in an opposite direction to the first rotating direction as it moves away from the center axis J1. Thus, air sent out by the first impeller 21 with the first ribs 24 can be further reduced. This improves the sound characteristics of the first axial fan 2. Moreover, each first rib 24 is curved so as to be convex toward a downstream side of the rotating direction of the first impeller 21 when seen in the axial direction. Thus, the sound characteristics of the first axial fan 2 are further improved.

In the second axial fan 3, each of the second ribs 34 arranged on the air-outlet side of the second impeller 31 is arranged at an angle relative to a line extending from the radially inner end of that second rib 34 in the radial direction such that that second rib 34 moves farther away from that line in an opposite direction to the second rotating direction of the second impeller 31 as it moves away from the center axis J1, as in the first axial fan 2. Thus, interference of air sent out by the second impeller 31 with the second ribs 34 is further reduced. This contributes to improvement of the sound characteristics of the second axial fan 3. Moreover, each second rib 34 is curved to be convex toward a downstream side of the rotating direction of the second impeller 31. This also contributes to improvement of the sound characteristics of the second axial fan 3.

In both the first and second axial fans 2 and 3, each of the first and second ribs 24 and 34 is arranged at an angle relative to the line extending from its radially inner end in the radial direction. Thus, spreading of air sent by the first and second impellers 21 and 31 in a direction away from the center axis J1 is reliably suppressed. This improves air-sending efficiency of the counter-rotating fan 1.

In the first axial fan 2, the first ribs 24 are radially arranged about the center axis J1 at regular intervals. Thus, the first motor 22 can be supported in a stable manner. Similarly, the second ribs 34 are radially arranged about the center axis J1 at regular intervals in the second axial fan 3. Thus, the second motor 32 can be supported in a stable manner.

In the counter-rotating fan 1 of this preferred embodiment, the first and second housing members 23 and 33 preferably are independently formed and are then secured to each other to form a hollow housing surrounding the first and second impellers 21 and 31 from radially outside thereof. Thus, it is easy to form the housing for the counter-rotating fan 1 and to attach the first and second impellers 21 and 31 and the first and second motors 22 and 32 to the housing.

### Second Preferred Embodiment

A counter-rotating fan according to a second preferred embodiment of the present invention is now described. Except for the arrangement of the first ribs 24 relative to the second ribs 34, the counter-rotating fan of this preferred embodiment is preferably substantially the same as the counter-rotating fan 1 of the first preferred embodiment. Like components are labeled with like reference numerals throughout the drawings.

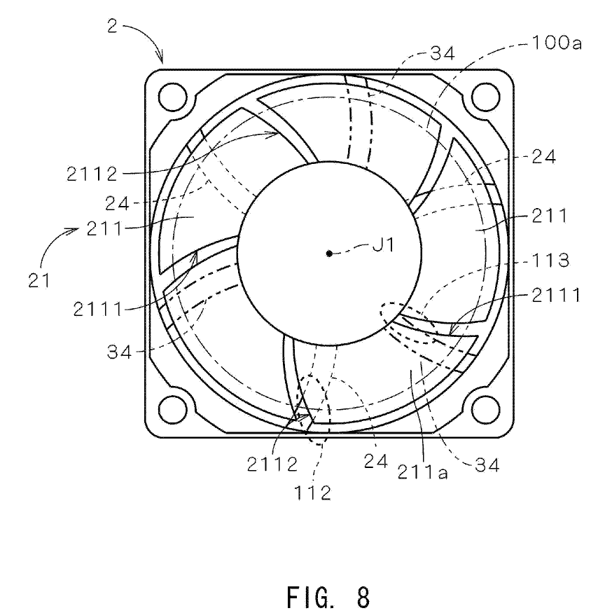

FIG. 8 is a plan view of the first axial fan 2 of the counter-rotating fan according to the second preferred embodiment, when seen from its air-inlet side. FIG. 8 also shows the second ribs 34 of the second axial fan 3 which sandwich the first impeller 21 with the first ribs 24 in the axial direction, with chain double-dashed line. FIG. 8 shows a state in which a radially outer portion of the trailing edge 2112 (the first rib side edge) of the first blade 211a is located above one first rib 24 in the axial direction, when seen from the above, as shown with broken line 112. Please note that a radially outer portion of an edge of a blade is a portion outside the center of that edge in the radial direction.

Referring to FIG. 8, when seen from the second fan side in the axial direction, while the radially outer portion of the trailing edge 2112 of the first blade 211a is located above the first rib 24, a radially inner portion of the leading edge 2111 (the second rib side edge) of that first blade 211a is located below one second rib 34, as shown with broken line 113. However, a radially outer portion of the leading edge 2111 is not located below any of the second ribs 34 but is located between two second ribs 34 when seen from axially above.

In the counter-rotating fan of this preferred embodiment, the first blades 211, the first ribs 24, and the second ribs 34 are regularly arranged about the center axis J1 at their own intervals. Thus, when seen from the second fan side in the axial direction, while the radially outer portion of the trailing edge 2112 of each first blade 211 is located axially above a given first rib 24, the radially outer portion of the leading edge 2111 of that first blade 211 is not located axially below any second rib 34 but is located between two second ribs 34.

With this configuration, air introduced into the first axial fan 2 by the first blades 211 with the second ribs 34 and air sent out from the first axial fan 2 by the first blades 211 with the first ribs 24 cannot simultaneously occur in the outside of the centers of the first blades 211 in the radial direction. In general, in counter-rotating axial fans, a flow rate of air is larger in the outside of the centers of the first blades 211 than in the inside of the centers (i.e., the center axis J1 side) in the radial direction. Thus, it is possible to improve the sound characteristics of the counter-rotating axial fan (especially, largely reduce a prominence ratio) by preventing simultaneous occurrence of interference of air with the air-inlet side ribs of the first blades 211 and interference of air with the air-outlet side ribs.

As shown in FIG. 8, in the counter-rotating fan of this preferred embodiment, the entire portion of each first rib 24 is not located axially below any second rib 34 when seen from axially above, as in the first preferred embodiment. Instead, each first rib 24 is entirely located between two second ribs 34 when seen from axially above. Thus, the sound characteristics of the counter-rotating fan are improved.

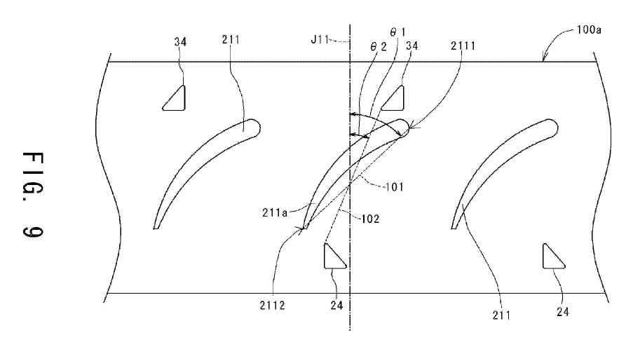

FIG. 9 is a cross-sectional view of the first blades 211, the first ribs 24, and the second ribs 34 of the counter-rotating fan of this preferred embodiment, taken along a cylindrical surface 100a which defines a cylinder having a predetermined diameter and centered on the center axis J1. The cylindrical surface 100a is shown in FIG. 8 with dashed dotted line. In FIG. 9, a portion of the cylindrical surface 100a is developed in the circumferential direction. The cylindrical surface 100a is located outside the centers of the first blades 211 in the radial direction. FIG. 9 also shows the axial direction J11 parallel or substantially parallel to the center axis J1.

As shown in FIG. 9, a line 101 connects the leading edge 2111 and the trailing edge 2112 of one first blade 211a to each other on the cylindrical surface 100a, and a line 102 connects a closest first rib 24 to the trailing edge 2112 of that first blade 211a and a closest second rib 34 to the leading edge 2111 of that first blade 211a on the cylindrical surface 100a. An angle θ1 of the line 101 and an angle θ2 of the line 102 with respect to the axial direction J11 are different from each other.

The angle θ1 of the line 101 is different from an angle of a line connecting a given first rib 24 to a given second rib 34 on the developed cylindrical surface 100a with respect to the axial direction J11. In the counter-rotating fan of this preferred embodiment, even when the diameter of the cylinder defined by the cylindrical plane 100a is changed to a given diameter between a diameter of a circle which passes through the center of every first blade 211a in the radial direction and an outer diameter of the first impeller 21, the angle θ1 of the line 101 on the developed cylindrical surface 100a with respect to the axial direction J11 is different from the angle of the line connecting a given first rib 24 to a given second rib 34 on the developed cylindrical surface 100a with respect to the axial direction J11.

In this preferred embodiment, all the first blades 211a are preferably arranged at the same angle relative to the center axis J1. The first blades 211a, the first ribs 24, and the second ribs 34 are regularly arranged about the center axis J1 at respective intervals, as in the first preferred embodiment. Thus, when the radially outer portion of each first blade 211, the first ribs 24, and the second ribs 34 are cut by a cylindrical surface which defines a cylinder centered on the center axis J1 and having a given diameter, the angle of the line connecting the leading and trailing edges of each first blade 211 on the developed cylindrical surface 100a with respect to the center axis J1 is different from the angle of the line connecting a given first rib 24 to a given second rib 34 on the cylindrical surface 100 with respect to the center axis J1. In other words, in the counter-rotating fan of this preferred embodiment, both the first rib 24 and the second rib 34 cannot be simultaneously located on an extended line of the line connecting the leading and trailing edges of each first blade 211 to each other in the outside of the radial centers of the first blades 211.

As a result, it is possible to prevent simultaneous occurrence of interference of air taken in by the first blades 211 with the second ribs 34 and interference sent out by the first blades 211 with the first ribs 24 in the outside of the radial centers of the first blades 211. Thus, the sound characteristics of the counter-rotating fan are greatly improved, and in particular, a prominence ratio is significantly reduced.

As described above, in order to further improve the sound characteristics more reliably in counter-rotating axial fans, it is preferable that, when seen from axially above, while a portion of the trailing edge 2112 of the first blade 211 is located axially above one first rib 24, the leading edge 2111 of that first blade 211 is entirely located between second ribs 34 adjacent to each other, as described in the first preferred embodiment. It is also preferable that the angle of the line connecting the leading and trailing edges of each first blade 211 with respect to the center axis J1 on the developed cylindrical surface which defines a cylinder having a given diameter and centered on the center axis J1 be different from the angle of the line connecting a given first rib 24 to a given second rib 34 on the developed cylindrical surface with respect to the center axis J1.

If the first ribs 24 cannot be arranged relative to the second ribs 34 in the same manner as that in the first preferred embodiment because of structural limitations and the like, the first ribs 24 and the second ribs 34 are arranged not to cover or be covered by the first blade 211 at the same time. In other words, the first and second ribs 24 and 34 are arranged such that the leading edge of each first blade 211 is not located below any second rib 34 while the trailing edge of that first blade 211 is at least partly located above one first rib 24 and vise versa. In addition, the angle of the line connecting the leading and trailing edges 2111 and 2112 of the first blade 211 to each other is set to be different from the angle of the line connecting the first rib 24 and the second rib 34 to each other. That is, the arrangement of the first blades 211, the first ribs 24, and the second ribs 34 in the second preferred embodiment is preferably used. With this configuration, the sound characteristics of the second axial fan 3 can be sufficiently improved.

Although the preferred embodiments of the present invention are described above, the present invention is not limited thereto but can be modified in various ways.

In the first and second preferred embodiments, cross-sectional shapes of the first and second ribs 24 and 34 on the developed cylindrical surface which defines a cylinder centered on the center axis J1 preferably are approximately triangular. However, the cross-sectional shapes of the first and second ribs 24 and 34 are not limited thereto. For example, the first and second ribs 24 and 34 may have such a cross-sectional shape allowing them to serve as stationary blades which further suppress spreading out of air sent out from the first and second impellers 21 and 31 in a direction away from the center axis J1.

It is not necessary that the number of the first ribs 24 is equal to the number of the second ribs 34. For example, four first ribs 24 and three second ribs 34 may be provided in the first axial fan 2 and the second axial fan 3, respectively.

In the counter-rotating fans of the above first and second preferred embodiments, the first and second housing members 23 and 33 are preferably secured to each other to form a housing. However, this housing may be formed by a single component.

In the counter-rotating fans, air may be taken therein from below the first axial fan 2 in FIG. 3 and discharged axially upward by changing the shapes, arrangement, and the turning direction of the first blades 211 and the second blades 311 in the first impeller 21 and the second impeller 31.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A counter-rotating fan comprising:
a first impeller having a plurality of first blades which are radially arranged about a center axis;
a first motor rotating the first impeller about the center axis in a first rotating direction;
a second impeller having a plurality of second blades which are radially arranged about the center axis, the second impeller arranged adjacent to the first impeller along the center axis;
a second motor rotating the second impeller in a second rotating direction opposite to the first rotating direction;
a housing surrounding the first and second impellers; and
a plurality of first ribs and a plurality of second ribs radially arranged about the center axis to connect the first motor and the second motor to the housing, respectively, the first ribs being arranged on a side of the first impeller opposite to the second impeller, the second ribs being arranged between the first impeller and the second impeller; wherein
when seen from the second fan side, while at least an outer portion of a first rib side edge of each of the first blades in a radial direction that is substantially perpendicular to the center axis is located above one of the first ribs, at least an outer portion of a second rib side edge of the first blade in the radial direction is located between two of the second ribs, the outer portion of each of the first rib side edge and the second rib side edge in the radial direction being a portion located outside a center of the corresponding edge in the radial direction.

2. A counter-rotating fan according to claim 1, wherein when seen from the second fan side, while the first rib side edge of each of the first blades is located above one of the first ribs, the second rib side edge of the first blade is entirely located between two second ribs.

3. A counter-rotating fan according to claim 1, wherein, when seen from the second fan side, each of the first ribs is located between two of the second ribs.

4. A counter-rotating fan according to claim 1, wherein a number of the first ribs is equal to a number of the second ribs.

5. A counter-rotating fan according to claim 1, wherein a number of the first ribs is not equal to a number of the second ribs.

6. A counter-rotating fan according to claim 1, wherein the first ribs are arranged on an air-outlet side of the first impeller from which air is discharged, and each of the first ribs is arranged at an angle relative to a line extending from a radially inner end of the first rib in the radial direction such that the first rib moves farther away from the line in a direction opposite to the first rotating direction as it moves away from the center axis.

7. A counter-rotating fan according to claim 1, wherein the first ribs are regularly arranged about the center axis, and the second ribs are regularly arranged about the center axis.

8. A counter-rotating fan according to claim 1, wherein the housing includes:
a first housing member surrounding the first impeller; and
a second housing member surrounding the second impeller, and wherein
the first ribs and the second ribs are connected to the first housing member and the second housing member, respectively.

9. A counter-rotating fan according to claim 1, wherein rotation of the first impeller in the first rotating direction and rotation of the second impeller in the second rotating direction create a current of air flowing in the same direction along the center axis.

10. A counter-rotating fan comprising:
a first impeller having a plurality of first blades which are radially arranged about a center axis;
a first motor rotating the first impeller about the center axis in a first rotating direction;
a second impeller arranged adjacent to the first impeller along the center axis, and having a plurality of second blades radially arranged about the center axis;
a second motor rotating the second impeller in a second rotating direction opposite to the first rotating direction;
a housing surrounding the first and second impellers; and
a plurality of first ribs and a plurality of second ribs radially arranged about the center axis to connect the first motor and the second motor to the housing, respectively, the first ribs being arranged on a side of the first impeller opposite to the second impeller, the second ribs being arranged between the first impeller and the second impeller; wherein
when a first line and a second line are defined, on a cylindrical surface which defines a cylinder having a diameter and centered on the center axis, as a line connecting both ends of each of the first blades to each other in the first rotating direction and a line connecting a given one of the first ribs to a given one of the second ribs, angles of the first line and the second line with respect to the center axis on the developed cylindrical surface are different from each other.

11. A counter-rotating fan according to claim 10, wherein the diameter of the cylinder is larger than a distance between the center axis and a center of each of the first blades in the radial direction.

12. A counter-rotating fan according to claim 10, wherein each of the first ribs is located between adjacent two of the second ribs.

13. A counter-rotating fan according to claim 10, wherein a number of the first ribs is equal to a number of the second ribs.

14. A counter-rotating fan according to claim 10, wherein the first ribs are arranged on an air-outlet side of the first impeller from which air is discharged, and each of the first ribs is arranged at an angle relative to a line extending from its radially inner end in the radial direction such that the first rib moves farther away from the line in a direction opposite to the first rotating direction as it moves away from the center axis.

15. A counter-rotating fan according to claim 14, wherein the second ribs are arranged on an air-outlet side of the second impeller from which air is discharged, and each of the second ribs is arranged at an angle relative to a second line extending from its radially inner end in the radial direction such that the second rib moves farther away from the second line in a direction opposite to the second rotating direction as it moves away from the center axis.

16. A counter-rotating fan according to claim 10, wherein the first ribs are regularly arranged about the center axis, and the second ribs are regularly arranged about the center axis.

17. A counter-rotating fan according to claim 10, wherein the housing includes:
a first housing member surrounding the first impeller; and
a second housing member surrounding the second impeller, and
the first ribs are connected to the first housing member and the second ribs are connected to the second housing member.

18. A counter-rotating fan comprising:
a first fan; and
a second fan, the first fan and the second fax being coaxially arranged and rotatable about a center axis in opposite directions relative to each other; and
a housing accommodating the first fan and the second fan, each of the first fan and the second fan including:
an impeller rotatable about a center axis of the first fan and the second fan and having a plurality of blades;
a motor rotating the impeller; and
a plurality of ribs connecting the motor to the housing; wherein
when seen from the second fan side, while at least an outer portion of a first rib side edge of each of the first blades in a radial direction that is substantially perpendicular to the center axis is located above one of the first ribs, at least an outer portion of a second rib side edge of the first blade in the radial direction is located between two of the second ribs, the outer portion of each of the first rib side edge and the second rib side edge in the radial direction being a portion outside a center of the corresponding edge in the radial direction.
